(19) United States
(12) Patent Application Publication
(10) Pub. No.: US 2017/0054363 A1
(43) Pub. Date: Feb. 23, 2017

(54) SYSTEMS AND METHODS FOR DC POWER CONVERSION

(71) Applicant: ALLEGRO MICROSYSTEMS, LLC, Worcester, MA (US)

(72) Inventors: Vijay Mangtani, Nashua, NH (US); Gregory Szczeszynski, Hollis, NH (US)

(73) Assignee: ALLEGRO MICROSYSTEMS, LLC, Worcester, MA (US)

(21) Appl. No.: 14/831,958

(22) Filed: Aug. 21, 2015

(51) Int. Cl. H02M 3/07

(52) U.S. Cl. CPC H02M 3/07

(57) ABSTRACT

A system for regulating voltage includes a power supply input node configured to receive a power supply voltage. The system also includes a voltage reduction circuit having an input node coupled to the power supply input node and an output node. The voltage reduction circuit is configured to generate a voltage at the output node that is lower than a voltage at the input node. The system also includes a voltage multiplier circuit having an input node and an output node and configured to generate a voltage its output node that is higher than a voltage at the input node of the voltage multiplier circuit. In embodiments, the voltage multiplier circuit may be a charge pump and the voltage reduction circuit may be a buck converter.

### FIELD

This disclosure relates to DC power conversion and, more particularly, to DC power conversion in the presence of a power source with relatively large power swings.

### BACKGROUND

Modern automobile designs include an increasing amount of advanced electronics. Sophisticated electronic devices, such as processor-based head units or entertainment systems, global positioning systems, smart phone or iPod™ interfaces, and other electronic devices and interfaces are common options in many vehicles. In addition, in-car processors that manage vehicular systems such as brakes and transmissions are also becoming more sophisticated. These sophisticated electronics are often sensitive to swings in power supply voltage. A spike or dip in supply voltage can reset or even damage these devices.

When used in automotive applications, the power supply for these electronic devices originates with an automobile battery. The battery supplies a nominal voltage of twelve volts, but the battery voltage is subject to very large voltage swings during operation of an automobile. For example, when an automobile engine is undergoing starting, due to a high current draw of an electric starter motor, the battery voltage can experience a large drop in voltage, down to a minimum of about four volts. Shortly thereafter, when the high current draw abruptly stops, voltage on wiring in the automobile, and/or the battery voltage, can experience a very high voltage, i.e., a voltage transient, above fifty volts, for example, one hundred volts, due to inductance in the starter motor, in the battery, and in the automobile wiring.

Electronics used in automobiles, and in some other applications as well, must both survive the high voltage and also be able to operate at the minimum battery voltage, e.g., four volts.

### SUMMARY

In an embodiment, an electronic circuit includes a power supply input node configured to receive a power supply voltage. The system also includes a voltage reduction circuit having an input node coupled to the power supply input node and an output node. The voltage reduction circuit may be configured to generate a voltage at the output node that is lower than a voltage at the input node. The system also includes a voltage multiplier circuit having an input node and an output node and configured to generate a voltage at the output node of the voltage multiplier circuit that is higher than a voltage at the input node of the voltage multiplier circuit. The input node of the voltage multiplier circuit may be coupled to the output node of the voltage reduction circuit, and the output node of the voltage multiplier circuit may be configured to provide power to a load.

In embodiments, the voltage multiplier circuit may be a charge pump and the voltage reduction circuit may be a buck converter.

### BRIEF DESCRIPTION OF THE DRAWINGS

The foregoing features may be more fully understood from the following description of the drawings. The drawings aid in explaining and understanding the disclosed technology. Since it is often impractical or impossible to illustrate and describe every possible embodiment, the provided figures depict one or more exemplary embodiments. Accordingly, the figures are not intended to limit the scope of the invention. Like numbers in the figures denote like elements.

FIG. 1 is a block diagram of a boost and buck converter circuit of the prior art.

FIG. 2 is a block diagram of a boost-buck circuit of the prior art.

FIG. 3 is a block diagram of an electronic circuit for regulating a voltage from an input power source susceptible to variations in voltage.

FIG. 4 is a block diagram of a system for regulating a voltage from an automotive power source susceptible to variations in voltage.

FIGS. 5A, 5B, 5C, 5D, and 5E are schematic diagrams of charge pump circuits.

FIG. 6 is a schematic diagram of a buck converter circuit.

### DETAILED DESCRIPTION

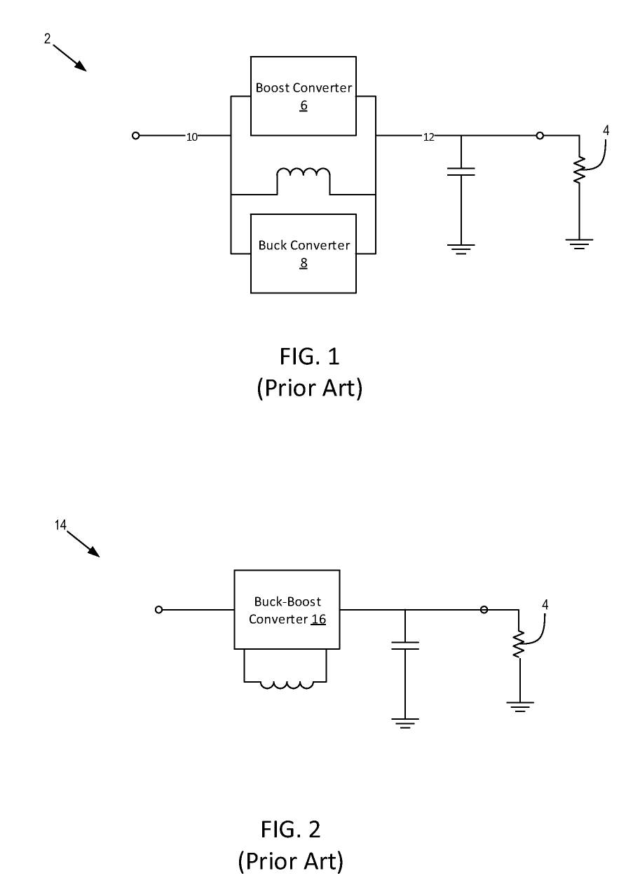

FIG. 1 is a block diagram of a system 2 of the prior art for providing power to a load 4. System 2 receives power from a source and provides a regulated output voltage to load 4. As shown, system 2 comprises a boost converter 6 in parallel with a buck converter 8. Boost converter 6 and buck converter 8 are coupled to an input terminal 10 and an output terminal 12. Input terminal 10 is configured to receive power from a power source. If the voltage at input terminal 10 is too low, the boost converter is used to boost the voltage to provide a desired voltage on output terminal 12. On the other hand, if the voltage at input terminal 10 is too high, the buck converter can reduce the voltage to provide regulated, predetermined voltage on output terminal 12. Switching circuitry (not shown) can be used to enable and disable boost converter 6 and buck converter 8 depending on whether the input voltage at terminal 10 is higher or lower than the desired output voltage. Although system 2 provides a regulated output voltage, it is susceptible to noise caused by switching (e.g. alternately enabling and disabling) between boost converter 6 and buck converter 8.

FIG. 2 is a block diagram of another system 14 of the prior art. System 14 also receives power from a source and provides a regulated voltage to load 4. Instead of parallel boost and buck converters, system 14 uses a buck-boost converter circuit 16 to generate a regulated output voltage. Buck-boost converter 16 contains circuitry to boost, i.e., to achieve the regulated output voltage if the input voltage is below the output voltage and to buck, i.e., to achieve the regulated output voltage if the input voltage is above the regulated output voltage. However, buck-boost converters can be inefficient, waste energy, and produce unwanted heat.

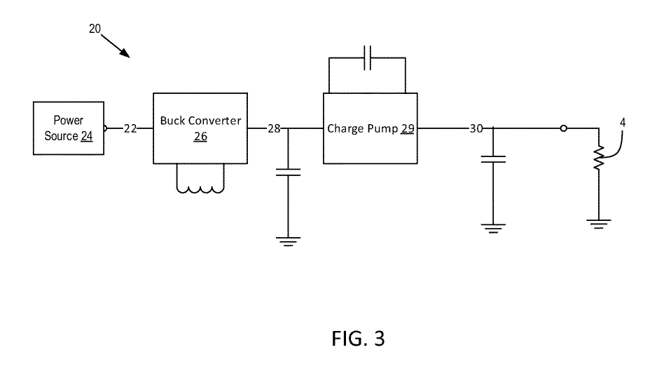

FIG. 3 is a block diagram of an electronic circuit 20 for providing power to a load 4. Although shown as a resistor, load 4 can be any type of load including, but not limited to, a resistive load, an inductive load, a capacitive load, an electronic device, an electronic circuit, a voltage or power regulator, a processor, etc. Electronic circuit 20 includes an input terminal 22 configured to receive power from a power source 24. In an embodiment, power source 24 is a voltage source such as an automotive battery and/or automotive alternator or other power source subject to swings in output voltage. The voltage output of power source 24 may range from less than four volts to more than sixty or more than one hundred volts.

Electronic circuit 20 includes a DC to DC converter, e.g. voltage reduction circuit 26, which may be a buck converter, coupled to input terminal 22 to receive power from power source 24, and to provide a predetermined regulated output voltage on terminal 28. Electronic circuit 20 also includes a voltage multiplier circuit 29, which may be a charge pump, coupled to receive an input voltage from terminal 28 and produce a predetermined output voltage on terminal 30. The output of charge pump 30 provides power to load 4. Electronic circuit 20 can also include various bulk capacitors and/or filtering capacitors (including those shown in FIG. 3) or other electrical circuits that are required by the design and that receive the predetermined output voltage from node 30.

In an embodiment, electronic circuit 20 is configured to produce a relatively stable output voltage at terminal 30, despite potential swings in voltage of power source 24. Electronic circuit 20 can be configured to provide a predetermined (e.g., regulated) output voltage to load 4. It will be understood that that charge pump 29 multiples the regulated output voltage of the buck converter by a predetermined scaling factor. (e.g., but two) In an embodiment, electronic circuit 20 may provide five volts, twelve volts, twenty volts, or any other desired voltage to load 4, despite potential swings in voltage from power source 24. Electronic circuit 20 may also be configured to provide one Amp or more of current to load 4. Of course, electronic circuit 20 can also provide less current if desired, or if the load draws less current.

In order to provide a desired output voltage, buck converter 26 and charge pump 29 may be configured to generate the output voltage at the load 4 so that the output voltage is maintained at a desired level. To this end, for example, if the voltage at terminal 22 is higher than the regulated output voltage of buck converter 26 (i.e. the voltage at node 28), buck converter 26 may down-convert the input voltage and generate the regulated output voltage on terminal 28. In some embodiments, the regulated output voltage at the terminal 28 is small, for example, three volts, so that the buck converter 26 can operate properly in regulation with input voltages down to low input voltages, for example, at most four volts, and also up to high voltage, for example, one hundred volts.

However, since buck converter 26 is configured to reduce voltages, if the voltage at terminal 22 is lower than the regulated output voltage at terminal 28, the regulated output voltage at terminal 28 may follow the low input voltage at terminal 22, and thus, may not be regulated. For example, if the buck converter 26 is configured to provide a three volt regulated output voltage on terminal 28, and the voltage on terminal 22 is greater than four volts, then buck converter will regulate its output so that the regulated voltage on terminal 28 is three volts. However, if the buck converter 26 is configured to provide a three volt regulated output voltage on terminal 28, and the voltage on terminal 22 is less than four volts, then buck converter may not regulate the output and the voltage at terminal 28 may follow the voltage at terminal 22. Thus, because of buck converter 26, the voltage at terminal 28 may always be equal to or lower than the intended regulated voltage level at terminal 28.

The charge pump 29 may be configured to receive the voltage at terminal 28, multiply the voltage by a predetermined scaling factor, e.g., two, and provide the desired output voltage at terminal 30. The charge pump 29 can boost the voltage at the terminal 28 to produce the desired output voltage. Thus, if the voltage provided by power source 24 is high, buck converter 26 can lower the voltage to a regulated output voltage and charge pump 29 can increase the regulated output voltage at terminal 28 to generate the desired output voltage at terminal 30. This arrangement can function (i.e., provide a stable desired output voltage at terminal 30) with both low input voltages and high input voltages at terminal 22.

In an embodiment, charge pump 29 is a multiplying charge pump or multi-mode pump that provides an output voltage that is a fixed multiple of its input voltage. For example, if charge pump 29 is a 2× charge pump, charge pump 29 may provide an output voltage at terminal 30 that is twice the voltage at terminal 28. Charge pump 29 can be configured to provide an output that is any multiple of its input. For example, charge pump 29 can multiply its input by factors of 1.2, 1.5, 2.0, 3.0, 4.0, 5.0, or any other factor as required by design.

In an embodiment, buck converter 26 may be configured to produce a regulated output voltage at terminal 28 that is lower than the desired output voltage at terminal 30. In such an embodiment, as long as the voltage at terminal 22 is greater than the regulated output voltage at terminal 28, buck converter 26 will down-convert the voltage to produce the regulated voltage at terminal 28. Charge pump 29 will boost the voltage at terminal 28 so that it generates the desired output voltage at output terminal 30.

In an embodiment, the circuits of electronic circuit 20 may be integrated circuits formed on a silicon substrate. The integrated circuits may be packaged within a molded package that encapsulates them. Electronic circuit 20 may include a lead frame and leads connecting various inputs and outputs of electronic circuit 20 (for example input terminal 22 and output terminal 30) to external pins of the package so that the integrated circuits can be connected to external circuitry, loads, and power supplies.

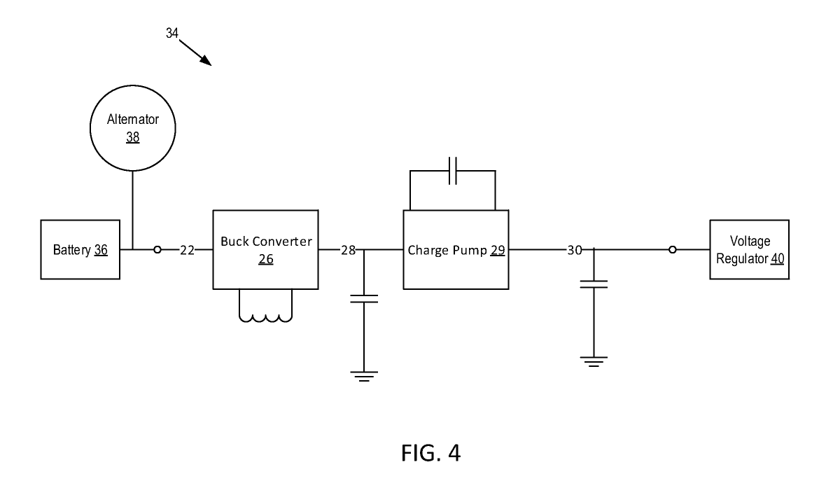

FIG. 4 is a block diagram of an automotive system 32 for supplying power to a voltage regulator load 34. System 32 includes buck converter 26, charge pump 29, and terminals 22, 28, and 30 as described above.

System 34 also includes an automotive battery 36 and an alternator 38. Battery 36 and alternator 38 are configured to generate a nominal voltage of about 12 volts to about 14 volts at terminal 22. However, the voltage generated at terminal 22 may temporarily vary from less than four volts to one hundred volts or more. For example, if the car is starting, the starter motor may draw large current from battery 36 and thus reduce the voltage at terminal 22 to four volts or lower. When the starter motor turns off, the starter motor can produce a flyback voltage on terminal 22 of up to sixty volts, or up to one hundred volts, or more. Other automotive events also can cause the voltage at terminal 22 to increase or decrease.

System 34 also includes a voltage regulator 40 coupled to receive the desired output voltage at terminal 30. Although not shown, voltage regulator 40 may provide power to various automotive circuits and devices, including, but not limited to: hydraulic pumps, audio units and head units, GPS systems, automotive computers, an alarm system, transmission systems, etc. In an embodiment, voltage regulator 40 may be damaged or may not be able to operate if connected directly to battery 36 due to the large variation in voltage at terminal 22.

In operation, buck converter 26 receives a voltage from battery 36 and/or alternator 38, and generates a regulated voltage at terminal 28. Charge pump 29 receives the regulated voltage at terminal 28 and boosts the voltage to generate the predetermined desired output voltage at terminal 30. Voltage regulator 40 receives the desired output voltage at terminal 30 and provides power to other automotive circuits.

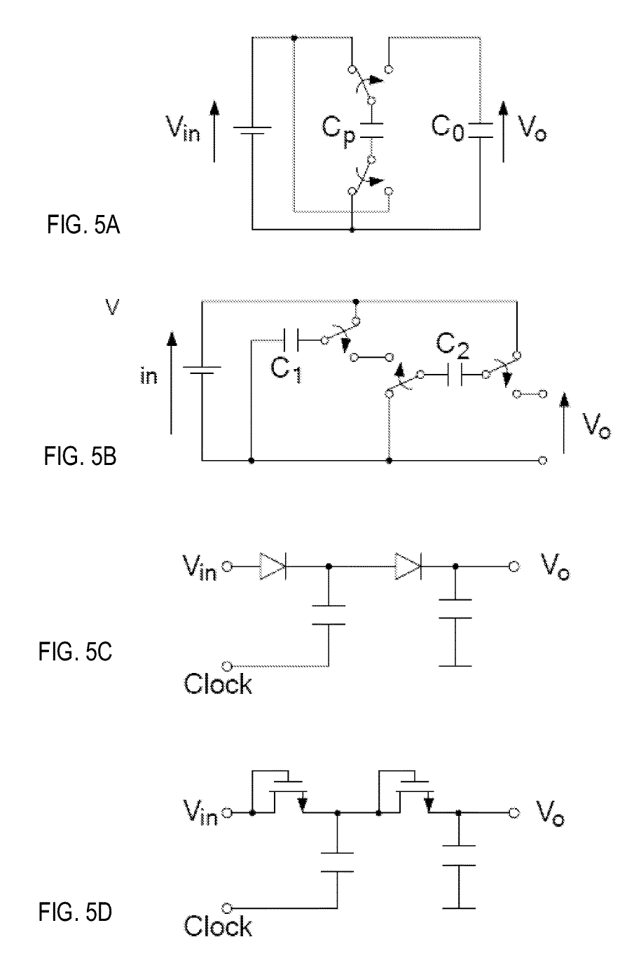

Charge pump 29 can be implemented with various charge pump designs. Referring now to FIGS. 5A-5D, four different configurations and designs of charge pumps are shown, each capable of generating at its respective output a voltage higher than a voltage provided at its respective input. Each of these charge pumps is a doubling charge pump configured to generate a voltage approximately double the voltage provided at the input. However, as noted above, charge pumps designed to increase voltage by other multiplying factors can be used.

It will be understood how to configure other charge pumps that can triple or quadruple an input voltage, or that can increase the voltage to a level between one and two times the input voltage. Such charge pumps can also be used in the systems described above.

A size of the capacitors is selected based upon a variety of factors. The factors include, but are not limited to, a frequency are which switches are toggled or a frequency used as a clock signal, an average current draw extracted from the charge pumps, and an amount of ripple that is desired in the output voltage.

Referring now to FIG. 5E, another exemplary charge pump acts as a doubling charge pump. The charge pump includes four switches, S1-S4 disposed upon a substrate and two capacitors disposed apart from the substrate (but which, in some embodiments, can be upon the substrate). A clock signal, CLK, is operable to close some of the switches at any particular time, and to close other ones of the switches at other times. The clock signal can be provided by external automotive circuitry, in an embodiment.

In a first phase of operation (i.e., during a first state of the clock signal), the switches S1, S4 are closed and the switches S2, S3 are open. In a second phase of operation (i.e., during a second different state of the clock signal), the switches S2, S3 are closed and the switches S1, S4 are open.

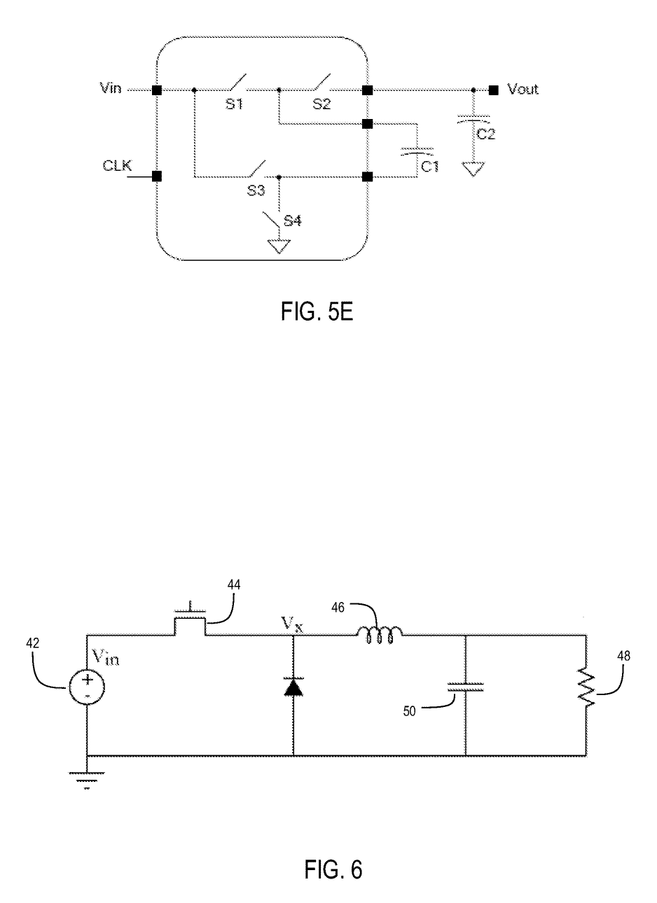

It is possible to fabricate capacitors directly upon a substrate using integrated circuit fabrication techniques, e.g., metal layers separated by a dielectric material. Some techniques are described in U.S. Pat. No. 7,573,112, issued Aug. 11, 2009, assigned to the assignee of the present application, and incorporated by reference herein in its entirety. In some embodiments, the capacitors of the charge pumps of FIGS. 5A-5E and of the buck converter switching regulator of FIG. 6 are fabricated by such techniques.

Buck converter 26 can be implemented with various buck converter designs. Referring to FIG. 6, a buck converter is coupled to an input power source 42, which may be an automotive battery and/or alternator. A switch 44 is configured to selectively couple power source 42 to inductor 46. The switching frequency and pulse width of switch 44 can be controlled by external circuitry (not shown) which may include a switching regulator. When switch 44 is open, current can flow from power source 42 through inductor 46 and into a load 48. During this time, capacitor 50 may charge. When switch 44 is closed, current cannot flow from power source 42 to load 48. Rather, current flows through diode 50, though inductor 46, and into load 48. During this time, capacitor 50 may discharge. The switching frequency and pulse width of switch 44 can control the charge level of capacitor 50 (and thus the voltage across load 48).

Having described preferred embodiments, which serve to illustrate various concepts, structures and techniques, which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims. All references cited herein are hereby incorporated herein by reference in their entirety.

What is claimed is:

1. An electronic circuit, comprising:
a power supply input node configured to receive a power supply voltage from an automotive power source susceptible to voltage swing from about four volts to about sixty volts;
a voltage reduction circuit having an input node coupled to the power supply input node and an output node, the voltage reduction circuit configured to generate a voltage at the output node that is lower than a voltage at the input node; and
a voltage multiplier circuit having an input node and an output node and configured to generate a voltage at the output node of the voltage multiplier circuit that is higher than a voltage at the input node of the voltage multiplier circuit, wherein the input node of the voltage multiplier circuit is coupled to the output node of the voltage reduction circuit, wherein the output node of the voltage multiplier circuit is configured to provide power to a load.

2. The electronic circuit of claim 2 wherein the electronic circuit is configured to provide a current of up to one Amp to the load.

3. The electronic circuit of claim 1 wherein the load comprises a voltage regulator.

4. The electronic circuit of claim 3 wherein the voltage reduction circuit comprises a DC to DC converter.

5. The electronic circuit of claim 4 wherein the voltage reduction circuit comprises a Buck converter.

6. The electronic circuit of claim 1 wherein the power supply input node is further configured to receive the power supply voltage that can vary from about five Volts to about forty Volts.

7. The electronic circuit of claim 1 wherein the input node of the voltage reduction circuit is configured to receive a nominal input voltage in a range of about twelve Volts to about fourteen Volts.

8. The electronic circuit of claim 1 wherein the voltage multiplier circuit is adjustable and is further configured to produce an output voltage that is either higher, lower, or the same as the power supply voltage.

9. The electronic circuit of claim 1 wherein the voltage multiplier circuit comprises a charge pump.

10. The electronic circuit of claim 9 wherein the charge pump is a multi-mode pump.

11. The electronic circuit of claim 9 further comprising:
a semiconductor substrate, wherein the voltage reduction circuit, the voltage multiplier circuit, a sensing element, or a combination thereof comprise a plurality of active electronic components formed upon the semiconductor substrate;
a lead frame coupled to the semiconductor substrate, wherein the lead frame comprises a plurality of leads; and
a mold compound encapsulating the semiconductor substrate and covering a portion of the lead frame, wherein the voltage multiplier circuit comprises a discrete capacitor that is electrically coupled to the semiconductor substrate and encapsulated by the mold compound.

12. The electronic circuit of claim 11 wherein the discrete capacitor is directly coupled to the lead frame apart from the semiconductor substrate.

13. The electronic circuit of claim 12 wherein the discrete capacitor comprises a plurality of layers upon the substrate.

14. The electronic circuit of claim 1 wherein the voltage multiplier circuit comprises low power switches.

15. The electronic circuit of claim 1 wherein the output node of the voltage multiplier circuit is configured to produce a relatively steady-state output power signal in the presence of variations in the power supply voltage.

16. The electronic circuit of claim 1 wherein the output node of the voltage multiplier circuit is configured to be coupled to an automotive voltage regulator load.

17. The electronic circuit of claim 1 wherein the voltage reduction circuit is configured to produce a voltage that follows the voltage at the input node of the voltage reduction circuit if the voltage at the input node of the voltage reduction circuit is less than a regulated output voltage of the voltage reduction circuit.
